(19) United States
(12) Patent Application Publication
(10) Pub. No.: US 2014/0070658 A1
(43) Pub. Date: Mar. 13, 2014

(54) LAMINATION ASSEMBLY INCLUDING AN INTER-LAMINATION THERMAL TRANSFER MEMBER FOR AN ELECTRIC MACHINE

(71) Applicant: Colin Hamer, Noblesville, IN (US)

(72) Inventor: Colin Hamer, Noblesville, IN (US)

(73) Assignee: REMY TECHNOLOGIES, L.L.C., Pendleton, IN (US)

(21) Appl. No.: 13/608,673

(22) Filed: Sep. 10, 2012

(51) Int. Cl. F28F 7/00; H02K 1/20; B23Q 17/00; H02K 1/06

(52) U.S. Cl. 310/216.004; 165/185; 29/407.09

(57) ABSTRACT

A lamination assembly having a lamination stack including a plurality of lamination members, and at least one inter-lamination thermal transfer member coupled to at least one of the plurality of lamination members. The at least one inter-lamination thermal transfer member establishes a heat dissipation path from the lamination stack.

### BACKGROUND OF THE INVENTION

Exemplary embodiments pertain to the art of electric machines and, more particularly, to a lamination assembly including an inter-lamination thermal transfer member for an electric machine.

Electric machines generally include a housing that encloses a rotor and a stator. The rotor typically includes a rotor hub. The rotor hub is joined to a shaft that is supported by one or more bearings. The rotor hub supports a plurality of rotor windings that, when acted upon by a magnetic field generated by the stator, cause the rotor to rotate. In some cases, the rotor will include laminations that support permanent magnets. The permanent magnets also interact with the magnetic field supplied by the stator causing the rotor to rotate. Heat build-up in the plurality of laminations may have a detrimental effect on the permanent magnets. Many electric machines guide a coolant through the housing to absorb heat from the laminations. The coolant may take the form of a fluid flow including both gases and liquid.

### BRIEF DESCRIPTION OF THE INVENTION

Disclosed is a lamination assembly having a lamination stack including a plurality of lamination members, and at least one inter-lamination thermal transfer member coupled to at least one of the plurality of lamination members. The at least one inter-lamination thermal transfer member establishes a heat dissipation path from the lamination stack.

Also disclosed is an electric machine including a housing, a stator fixedly mounted relative to the housing and a rotor rotatably mounted relative to the stator and the housing. The rotor includes a rotor hub that supports a lamination assembly. The lamination assembly includes a lamination stack having a plurality of lamination members, and at least one inter-lamination thermal transfer member coupled to at least one of the plurality of lamination members. The at least one inter-lamination thermal transfer member establishes a heat dissipation path from the lamination stack.

Further disclosed is a method of forming a lamination assembly. The method includes aligning a plurality of lamination members, and positioning at least one inter-lamination thermal transfer member on at least one of the plurality of lamination members.

### BRIEF DESCRIPTION OF THE DRAWINGS

The following descriptions should not be considered limiting in any way. With reference to the accompanying drawings, like elements are numbered alike:

FIG. 1 depicts an electric machine having a lamination assembly provided with an inter-lamination thermal transfer member in accordance with an exemplary embodiment;

FIG. 2 depicts a perspective view of the lamination assembly of FIG. 1; and

FIG. 3 depicts an exploded view of the lamination assembly of FIG. 2.

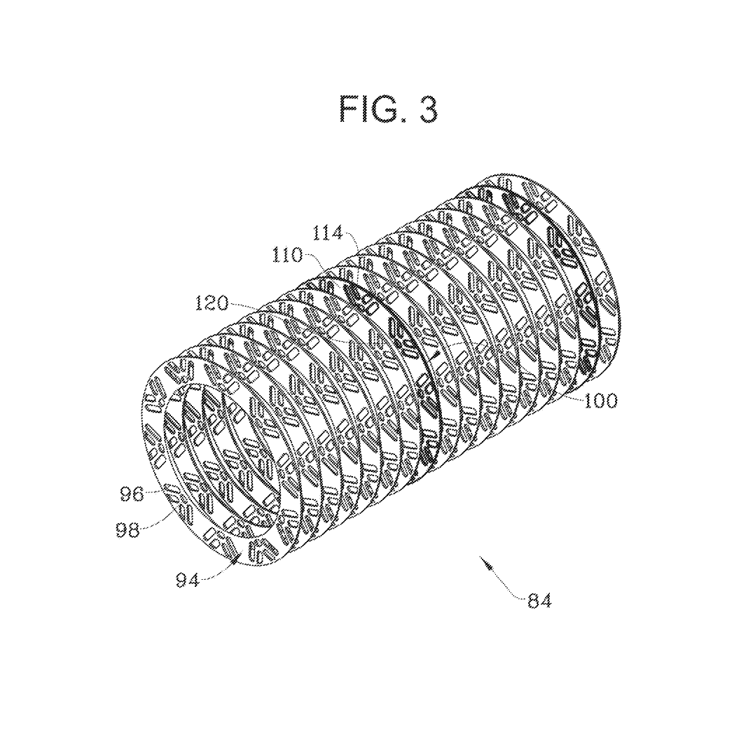

### DETAILED DESCRIPTION OF THE INVENTION

A detailed description of one or more embodiments of the disclosed apparatus and method are presented herein by way of exemplification and not limitation with reference to the Figures.

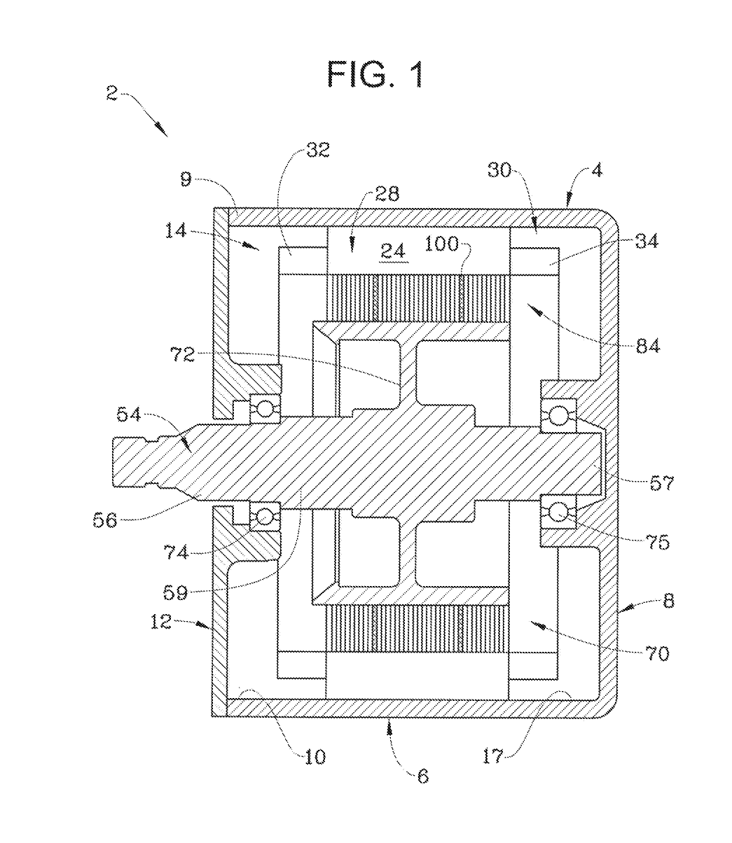

A permanent magnet electric machine in accordance with an exemplary embodiment is indicated generally at 2 in FIG. 1. Electric machine 2 includes a housing 4 having an annular side wall 6 that extends from a first end wall 8 to a cantilevered end 9 defining an opening 10. A second end wall or cover 12 is coupled to cantilevered end 9 and extends across opening 10. Annular side wall 6, first end wall 8 and cover 12 collectively define an interior portion 14. Annular side wall 6 includes an inner surface 17. At this point it should be understood that annular side wall 6 may take on many geometries and should not be considered to be limited to being circular. Electric machine 2 is further shown to include a stator 24 arranged on inner surface 17. Stator 24 includes a body or stator core 28 that supports a plurality of stator windings 30 having a first end turn portion 32 and a second end turn portion 34.

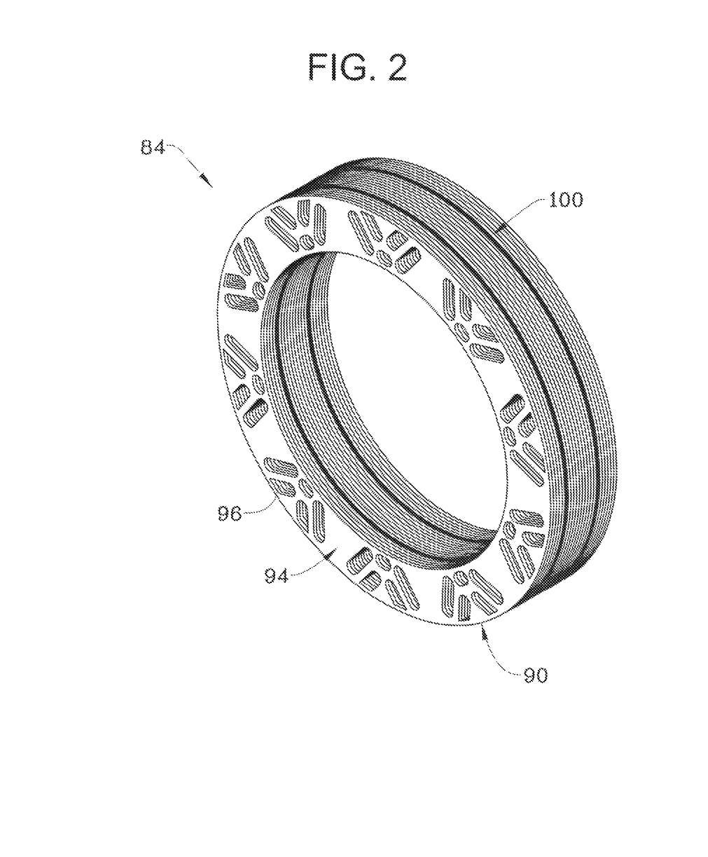

Electric machine 2 is also shown to include a shaft 54 rotatably supported within housing 4. Shaft 54 includes a first end 56 that extends to a second end 57 through an intermediate portion 59. Shaft 54 supports a rotor assembly 70. Rotor assembly 70 includes a hub 72 including a first bearing 74 that supports first end 56 relative to second end wall or cover 12, and a second bearing 75 that supports second end 57 relative to first end wall 8. Rotor assembly 70 includes a lamination assembly 84. Lamination assembly 84 includes a lamination stack 90 that supports a plurality of magnets (not shown). Lamination stack 90 includes a plurality of lamination members, one of which is indicated at 94. As shown in FIG. 2, each of the plurality of lamination members 94 include a plurality of slots 96 and passages 98. Slots 96 are configured to align with one another to form magnet receiving zones (not separately labeled) that support the magnets (not shown). Passages 98 are configured to align with one another to form coolant passages (not separately labeled) that guide a coolant such as air, oil, glycol or the like through lamination assembly 84. In accordance with one aspect of the exemplary embodiment, each lamination member 94 is formed from a material having a first thermal conductivity. For example, lamination members 94 may be formed from steel.

In accordance with an exemplary embodiment, lamination assembly 84 also includes one or more inter-lamination thermal transfer members, one of which is indicated at 100. In the exemplary embodiment shown, inter-lamination thermal transfer members 100 are inserted between adjacent ones of the plurality of lamination members 94. Inter-lamination thermal transfer member 100 includes a body 110 including a plurality of slots 114 and a plurality of passages 120 that align with slots 96 and passages 98 in the plurality of lamination members 94.

In further accordance with an exemplary embodiment, body 110 is formed from a thermally conductive media. More specifically body 110 is formed from a media having a second thermal conductivity that is greater than the first thermal conductivity of lamination members 94. In accordance with an aspect of the exemplary embodiment, body 110 is formed from a thermally conductive paper. In accordance with another aspect of the exemplary embodiment, body 110 is formed from a composite material including a ceramic, a silicone and/or an epoxy. The ceramic may include boron nitride, beryllium oxide, aluminum oxide and or combinations thereof. Inter-lamination thermal transfer member 100 may also be formed from graphite. Inter-lamination thermal transfer member 100 is configured to guide thermal energy from lamination assembly 84.

At this point it should be understood that the inter-lamination thermal transfer member provides a thermal flow path that guides heat from the lamination assembly. Rejecting heat from the lamination assembly increases an overall service life of the electric machine by reducing thermal forces that may de-magnetize magnets arranged in the plurality of laminations. The inter-lamination thermal transfer member also enables a power increase by facilitating heat rejection from the plurality of magnets provided in the lamination assembly. It should also be understood that the number of inter-lamination thermal transfer members provided in a lamination assembly may vary. Also, while shown as being interleaved with the plurality of lamination members, the inter-lamination thermal transfer member may also be provided on one, the other, or both outer ends of the lamination stack.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A lamination assembly comprising:
a lamination stack including a plurality of lamination members; and
at least one inter-lamination thermal transfer member coupled to at least one of the plurality of lamination members, the at least one inter-lamination thermal transfer member establishing a heat dissipation path from the lamination stack.

2. The lamination assembly according to claim 1, wherein the at least one inter-lamination thermal transfer member is interleaved between adjacent ones of the plurality of lamination members.

3. The lamination assembly according to claim 1, wherein the inter-lamination thermal transfer member is formed from a thermally conductive media including thermally conductive paper.

4. The lamination assembly according to claim 1, wherein the inter-lamination thermal transfer member is formed from a thermally conductive media comprising one of a graphite and a composite material having a ceramic and one of a silicone and an epoxy.

5. The lamination assembly according to claim 4, wherein the ceramic includes one of a boron nitride, a beryllium oxide, and an aluminum oxide.

6. The lamination assembly according to claim 1, wherein each of the plurality of lamination members include a first thermal conductivity and the at least one inter-lamination thermal transfer member includes a second thermal conductivity, the second thermal conductivity being greater than the first thermal conductivity.

7. The lamination assembly according to claim 6, wherein each of the plurality of lamination members comprises a steel.

8. The lamination assembly according to claim 1, wherein each of the plurality of laminations includes a plurality of slots that are aligned to form a plurality of magnet receiving zones.

9. The lamination assembly according to claim 8, wherein the at least one inter-lamination thermal transfer member includes a plurality of slots that correspond to and align with the plurality of slots in the plurality of laminations.

10. An electric machine comprising:
a housing;
a stator fixedly mounted relative to the housing;
a rotor rotatably mounted relative to the stator and the housing, the rotor including a rotor hub supporting a lamination assembly comprising:
a lamination stack including a plurality of lamination members; and
at least one inter-lamination thermal transfer member coupled to at least one of the plurality of lamination members, the at least one inter-lamination thermal transfer member establishing a heat dissipation path from the lamination stack.

11. The electric machine according to claim 10, wherein the at least one inter-lamination thermal transfer member is interleaved between adjacent ones of the plurality of lamination members.

12. The electric machine according to claim 10, wherein the at least one inter-lamination thermal transfer member is formed from a thermally conductive media including thermally conductive paper.

13. The electric machine according to claim 10, wherein the at least one inter-lamination thermal transfer member is formed from a thermally conductive media comprising one of a graphite and a composite material having a ceramic and one of a silicone and an epoxy.

14. The electric machine according to claim 13, wherein the ceramic includes one of a boron nitride, a beryllium oxide, and an aluminum oxide.

15. The electric machine according to claim 10, wherein each of the plurality of laminations includes a first thermal conductivity and the at least one inter-lamination thermal transfer member includes a second thermal conductivity, the second thermal conductivity being greater than the first thermal conductivity.

16. The electric machine according to claim 15, wherein each of the plurality of lamination members comprises a steel.

17. The electric machine according to claim 10, wherein each of the plurality of laminations includes a plurality of slots that are aligned to form a plurality of magnet receiving zones.

18. The electric machine according to claim 17, wherein the at least one inter-lamination thermal transfer member includes a plurality of slots that correspond to and align with the plurality of slots in the plurality of laminations.

19. A method of forming a lamination assembly, the method comprising:
aligning a plurality of lamination members; and
positioning at least one inter-lamination thermal transfer member on one of the plurality of lamination members.

20. The method of claim 20, wherein adding the at least inter-lamination thermal transfer member comprises inserting the at least one inter-lamination thermal transfer member between adjacent ones of the plurality of lamination members.
